(19) United States
(12) Patent Application Publication
(10) Pub. No.: US 2008/0178466 A1
(43) Pub. Date: Jul. 31, 2008

(54) Flame treatment process for bonded foam piping systems

(76) Inventor: Thomas Joseph Keyes, Forth Worth, TX (US)

Correspondence Address: Charles D. Gunter, Jr.;Whitaker, Chalk, Swindle & Sawyer, LLP, Suite 3500, 301 Commerce Street, Fort Worth, TX, 76102-4186, US

(21) Appl. No.: 11/698,463

(22) Filed: Jan. 26, 2007

(51) Int. Cl. B23P 17/00

(52) U.S. Cl. 29/890.14

(57) ABSTRACT

A method is shown for manufacturing a length of pre-insulated piping of the type having an inner steel carrier pipe surrounded by an outer layer of insulating foam and, in turn, an outer plastic waterproof jacket. The interior of the waterproof jacket is treated in a flame treatment process in order to ensure a more uniform bond between the layer of foam insulation and the outer waterproof plastic jacket.

### BACKGROUND OF THE INVENTION

1. Field of the Invention

The present invention relates to pre-insulated piping systems, and more specifically to a method for manufacturing a length of pre-insulated piping of the type having an inner steel carrier pipe surrounded by an outer layer of insulating foam which, in turn, is surrounded by an outer waterproof plastic jacket, in order to ensure a more uniform bond between the layer of foam insulation and the outer waterproof plastic jacket.

2. Description of the Prior Art

There are many instances in which insulated pipelines are needed. For example, distributed HVAC (heating, ventilation and air conditioning) applications utilize chilled water for cooling and steam for heating. The chiller and boiler are typically contained in a central location and the chilled water and steam are distributed to other locations. For example, on a school campus, the chiller and boiler may be located in a power plant building. The chilled water and steam are distributed to classrooms in separate buildings.

A set of insulated pipelines is used to convey the chilled water from the chiller to other locations and back to the chiller. Another set of insulated pipelines is used to carry the steam from the boiler to the other locations and back to the boiler. The insulated pipelines are usually located underground.

Insulated pipe is conventional and commercially available. There are predominately two types of piping systems in use: Class-A drainable dryable testable (DDT); and polyurethane or polyisocyanurate “bonded” foam systems. Both of these systems use an inner carrier pipe to convey fluid. Although steel is commonly used for the inner pipe which carries the media to be piped, copper or aluminum or other metals as well as fiberglass, PVC, and similar materials may be utilized, as well. The present application is directed toward the “bonded” foam type system. These systems utilize a steel pipe to convey fluid. Around the outside of the steel pipe is a layer of insulating foam such as, for example, polyisocyanurate foam. The foam layer is, in turn, surrounded by a jacket of a hard thermoplastic material (such as high density polyethylene, HDPE).

As a part of the foam curing process, the foam sets up or hardens within the outer jacket so as to bond to both the outer jacket and to the inner fluid conveying pipe. The plastic jacket protects the foam from mechanical damage and also provides a water tight seal to prevent corrosion of the steel pipe. In the bonded type system, the foam and outer jacket are not intended to move relative to the inner pipe. In the Class-A type system, on the other hand, the insulated inner pipe is designed to move independently of the associated outer jacket. In fact, there is an air gap between the inner pie and outer carrier pipe in the class-A type system.

As a result of these differences in the two designs, one of the most important engineering criteria for the traditional “bonded” foam type system is that it must be treated as a monolithic system. In other words, the foam must be uniformly bonded to both the inner carrier pipe and the outer jacket. However, the slick interior surface of the HDPE outer jacket poses certain problems in achieving a completely uniform adhesive bond between the foam layer and the outer protective jacket. Even if the interior of the outer HDPE jacket is treated with an abrasive treatment such as sand blasting, in some cases the bonding is non-uniform over at least portions of the contact area.

This type of non-uniform bonding can create problems in certain circumstances. For example, sections of insulated piping are sometime left outside in the weather, either at the manufacturer's plant, or at a job site, until they are needed. Any section of jacket and foam that are not completely and uniformly bonded together will allow for the potential of water to migrate into the system. Normally, this amount of water should be small and the potential detriment that may cause to the system would be insignificant. However, there is always the possibility of the system being submersed under water for a prolonged period (rainstorms during installation when the pipe is in a trench, but not yet completely installed are a problem that causes this because the trench fills with water and the pip is submerged under water until the trench can be pumped out). In these types of situations there is increased potential of more significant water migrating between areas of non bonding between the jacket and foam.

Thus, despite the advances which have been made in foam bonding technologies, a need exists for improvements in manufacturing methods for pre-insulated piping systems which will ensure a more uniform bond between the layer of foam insulation and the outer waterproof plastic jacket.

### SUMMARY OF THE INVENTION

The present invention provides a method of manufacturing a length of pre-insulated piping of the type having an inner steel carrier pipe surrounded by an outer layer of insulating foam and, in turn, an outer waterproof plastic jacket, in order to ensure a more uniform bond between the layer of foam insulation and the outer waterproof plastic jacket. The process begins with a cylindrical length of plastic (typically HDPE) jacket which has an exterior surface and an interior surface. The interior surface of the plastic jacket is flame treated in order to improve the adhesion qualities of the interior surface of the jacket. Next, an inner steel carrier pipe having an exterior and an initially open interior is provided. The inner steel carrier pipe is placed inside the plastic jacket to thereby create an annular space between the exterior surface of the steel carrier pipe and the interior surface of the plastic jacket. Lastly, foam insulation is injected within the annular space between the exterior surface of the steel carrier pipe and the interior surface of the plastic jacket. The foam fills the annular space and bonds with the inner steel carrier pipe and with the surrounding waterproof jacket.

The flame treatment of the interior of the plastic jacket can be performed in a number of different ways. For example, in one version of the method of the invention, the flame treatment is accomplished with a brush burner apparatus. A mounted brush flame apparatus is positioned within the interior of the cylindrical length of plastic jacket. The apparatus is mounted for movement longitudinally along the interior length of the jacket. Next, the brush flame apparatus is ignited and moved along the interior length of the jacket to thereby flame treat the interior surface of the plastic jacket. The flame treatment oxidizes the surface of the interior of the plastic jacket, thereby improving the adhesion properties of the jacket.

The brush flame apparatus can be constructed with a flame head having a plurality of flame openings which are directed toward an outer dispersion plate. The dispersion plate is positioned a selected distance from the flame head and positioned to deflect the associated flame radially outward toward the plastic jacket interior. In one form, the apparatus has a centralizer mechanism for centering the apparatus within the interior of the plastic jacket. For example, in one embodiment of the present invention, the centralizer is a plurality of spring legs mounted to the flame head.

Additional objects, features and advantages will be apparent in the written description which follows.

### BRIEF DESCRIPTION OF THE DRAWINGS

FIG. 1 is a simplified representation of a typical distributed HVAC system utilizing chilled water for cooling and steam for heating;

FIG. 2 is a schematic representation of an expansion loop in a pre-insulated pipeline of the type used in the HVAC system of FIG. 1;

FIG. 3 is a side view of a section of the outer thermoplastic jacket of the type used in the practice of the method of the invention;

FIG. 4 is a simplified view of the first step in the method of the invention in which the interior surface of the outer thermoplastic jacket is flame treated with a brush burner in order to increase the adhesion properties thereof;

FIG. 5 is a simplified view of the second step of the method of the invention in which the steel carrier pipe is placed within the outer thermoplastic jacket;

FIG. 6 illustrates the next step in the method of the invention in which an uncured foam insulating material is injected into the annular space between the outer thermoplastic jacket and the exterior surface of the steel carrier pipe;

FIG. 7 is a side view of a section of the insulated piping showing the cured foam which bonds to both the inner carrier pipe and to the surrounding thermoplastic jacket; and

FIG. 8 is a is an end view of a section of the completed bonded foam pre-insulated piping of the invention;

FIG. 9 is a simplified sectional view of the outer thermoplastic jacket showing one version of a brush burner apparatus of the type which could be used to flame treat the interior surface of the outer thermoplastic jacket in the first step of the method of the invention.

### DETAILED DESCRIPTION OF THE INVENTION

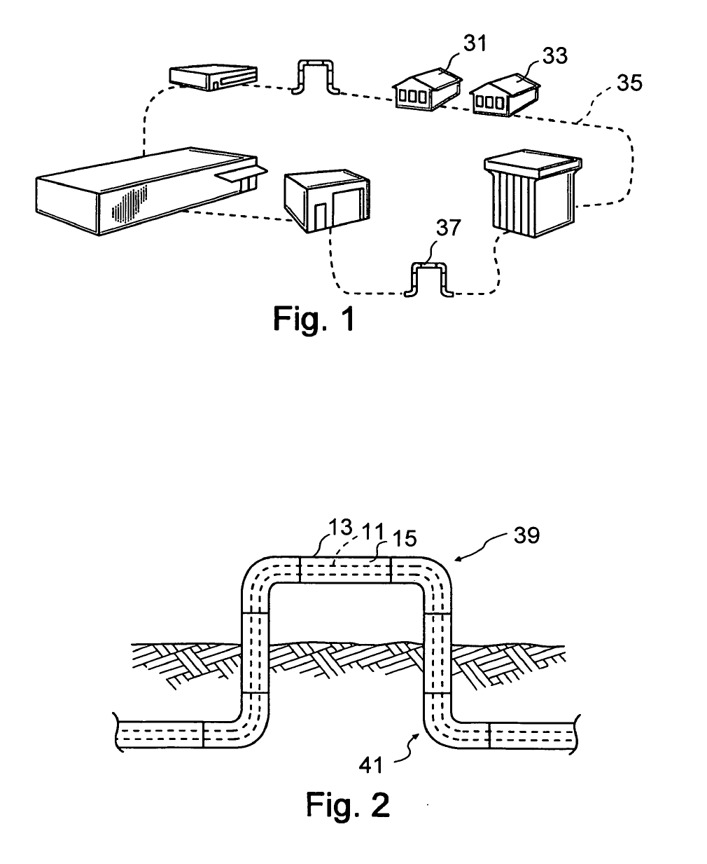

Turning first to FIGS. 1-2, there is illustrated a typical environment in which the pre-insulated piping systems of the invention might be employed. FIG. 1 shows a school campus having a number of isolated buildings 31, 33 connected by an underground insulated pipeline 35 carrying steam which at points includes right angle loops or elbows 37.

FIG. 2 is a schematic view of the standard piping installation of the type under consideration designated generally as 39. The installation 39 includes a number of coaxially oriented lengths of pipe. The installation may also include a number of angled fittings such as the right angle elbows (generally shown as 41) in FIG. 2. Each length of pipe includes an inner carrier pipe 11, typically formed of steel, an envelope of foamed insulation 15 surrounding the inner carrier pipe 11 and an outer protective jacket 13 surrounding the envelope of insulation. The joining ends of adjacent pipe lengths are affixed, as by being welded together, to form fixed joints, whereby the adjacent pipe lengths provide a continuous fluid conduit for conveying high temperature fluids. The jacket 13 is typically formed of high density polyethylene (HDPE) or a similar polyolefin type material. The following references, among others, teach the manufacture of such prior art systems: U.S. Pat. No. 3,793,4111; U.S. Pat. No. 4,084,842; and U.S. Pat. No. 4,221,405, all to Stonitsch et al.

The reference in this discussion to pipe “lengths” is intended to refer to standard available factory pre-insulated piping of the type previously described having an inner metal pipe surrounded by an envelope of foamed insulation, which in turn, is contained within a polyolefin jacket. As referred to briefly above, typical commercial practice involves the use of steel, copper, aluminum or alloy conveying pipes, open or closed cell polyurethane, polyisocyanurate, polystyrene or the like, foamed rigid insulation and polypropylene, polybutylene, polyethylene, polyvinylchloride and similar protective jackets.

The present invention is an improvement to presently available pre-insulated piping of the type which is commercially available and familiar to those in the relevant industries. Prior art pipe lengths of this general type are commercially available as standard factory type product. For example, such product is available from Thermacor Process, LP of Fort Worth, Tex., assignee of the present invention. One typical example is sold commercially as the HT-406 High Temp Steel Piping System. The published specifications for systems are as follows:

| | |
|---|---|
| Carrier Pipe- | |
| diameter less than about 2″ | A53 ERW Grade B, Std. Wt. |
| | Black Steel |
| diameter greater than about 2″ | A106 SML, Std. Wt. Black |
| | Steel |
| HDPE Jacket- | |
| Compatible with ASTM D3350 | |
| Specific Gravity (ASTM D792) | 0.941 min. |
| Tensile Strength (ASTM D638) | 3100 psi min. |
| Elongation Ultimate (ASTM D638) | 400% min. |
| Compressive Strength | 2700 psi min. |
| (ASTM D695) | |
| Impact Strength (ASTM D256) | 2.0 ft. lb/in. North Min. |
| Rockwell Hardness (ASTM D785) | D60 (Shore) min. |
| Polyisocyanurate Insulation- | |
| Density | >2.4 lbs/ft³ |
| “K” Factor | ≦0.14 @ 70° F., ≦0.24 @ 406° F. |
| Compressive Strength | >30 psi |
| Closed Cell Content | ≧90% |
| Minimum Thickness | ≧2.5″ @ 366° F., ≧3.0″ @ 406° F. |

The present invention has as its primary object to provide a method for manufacturing a length of pre-insulated piping of the type mentioned above, which method ensures a more uniform bond between the layer of foam insulation and the outer waterproof plastic jacket. As explained in the Background discussion, it is vital to the integrity of the pre-insulated piping system that a uniform bond be created between the insulating foam and the interior surface of the plastic jacket 13. The uniform bond keeps the system monolithic and also prevents undesired elements, such as moisture, to enter any air pockets or gaps between the foam and the plastic jacket, which could later result in damage to the piping system.

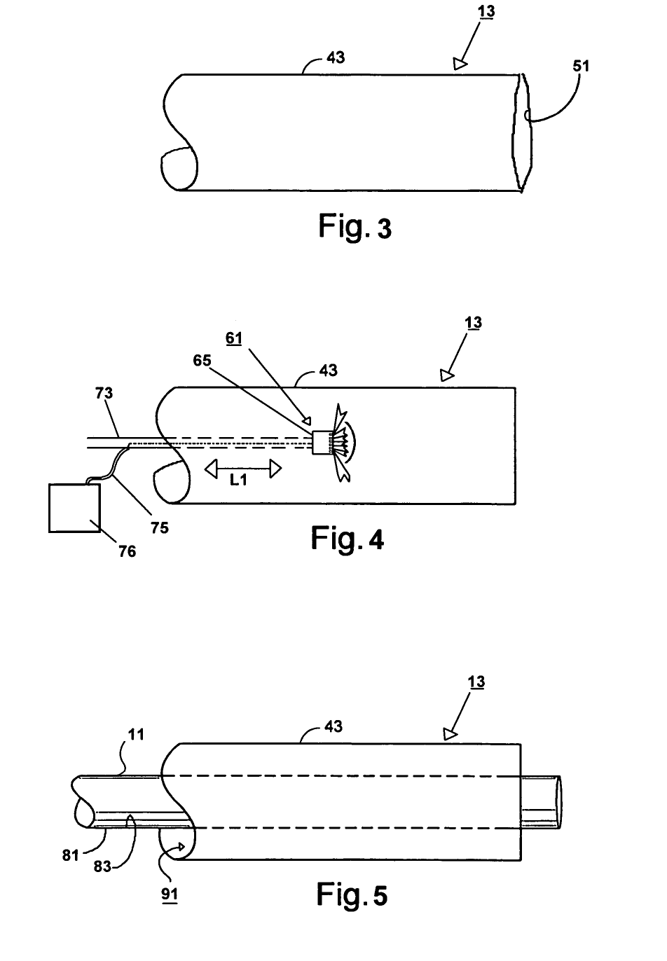

Turning now to FIG. 3, there is shown a section of the outer waterproof jacket 13 which, in this case, is formed of high density polyethylene (HDPE). HDPE is a linear polymer which is prepared from ethylene by a catalytic process. The absence of branching results in a more closely packed structure with a higher density and somewhat higher chemical resistance than low density polyethylene. HDPE is also somewhat harder and more opaque and it can withstand higher temperatures than low density polyethylene. The outer plastic jacket 13 is generally cylindrical and has an exterior 43 surface and interior 51 surface. The interior of the outer plastic jacket 13 is initially open. The jacket thickness is somewhere on the order of 40-50 mils. A typical section length of the jacket is, for example, 40 feet. Polyolefin materials, such as HDPE offer a number of advantages for use as an outer protective jacket. This family of materials offers exceptional environmental and chemical resistance as well as abrasion resistance.

While such qualities as abrasion resistance are of value for the exterior of the jacket, the “slick” nature of the interior surface of the jacket presents a problem as far as the adhesion qualities of the material. The method of the invention aims to improve the adhesion qualities of the waterproof plastic jacket by a physical process which is relatively simple to implement and economical to practice.

In the first step of the method of the invention, the interior surface of the HDPE jacket is treated by exposing the surface to an open flame for a selected period of time. The resulting oxidation of the jacket interior surface has been found to remarkably improve the adhesion properties of the surface, thereby allowing a more uniform foam bonding in the subsequent steps of the method. In the particular embodiment of the invention illustrated in FIG. 4, the flame treatment of the interior jacket surface is accomplished by the use of a special “brush flame” apparatus. It will be understood by those skilled in the art, however, that other similar devices might be employed to accomplish the scoring of the interior surface with an open flame.

FIG. 4 is a simplified illustration of a section of the polyethylene outer jacket, showing a brush flame apparatus 61 which is positioned within the interior 51 of the plastic jacket. In this case, the burner is a propane burner which is supplied from a bottle 76 and connecting conduit 75. In alternative embodiments of the present invention, the flame head could be supplied with, for example, acetylene or natural gas. The brush flame apparatus 61 is mounted for movement along the longitudinal axis of the jacket interior, generally shown along the path L, in FIG. 4. As shown in FIG. 4, the brush flame apparatus 61 is ignited and moved along the interior length of the plastic jacket 13, the movement being accomplished by any convenient means. While some sort of motorized vehicle or “pig” could be utilized, it is possible to simply move the burner by hand by means of an extension handle 73. In the preferred method, a worker simply pushes and then pulls the burner from one end of the section of jacket to the other. The exposure time is that amount of time that it takes the worker to accomplish the back and forth movement. Since the jacket is on the order of 140-150 mils minimum thickness, the exposure time does not appear to be critical and the back and forth movement through a roughly 40 foot length of jacket can be easily accomplished without any type of burn-through or damaging of the interior surface of the jacket. The oxidation of the interior surface which results provides a surfaces with improved adhesion properties which is “stickier” than the untreated surface.

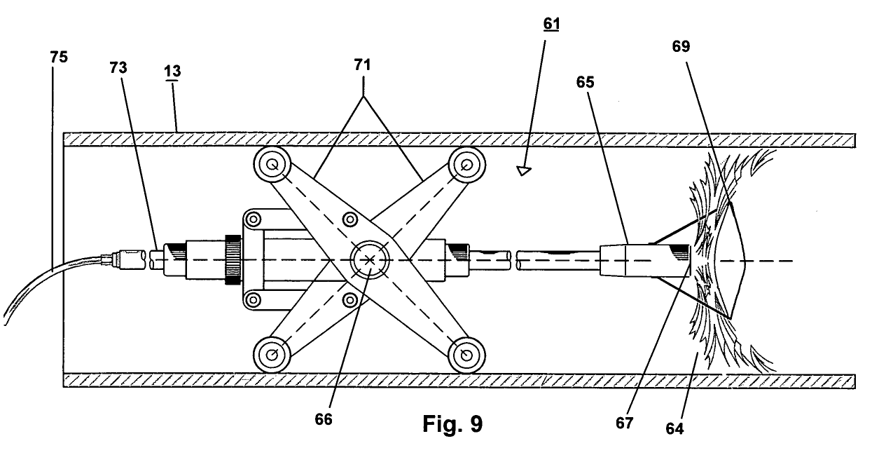

FIG. 9 shows one form of the brush flame apparatus which can be used to accomplish the flame treatment of the jacket interior. The brush flame apparatus 61 is made up of a flame head 65 with a plurality of flame openings 67 which are directed toward an outer dispersion plate 69. The inside surface of the plate 69 is preferably slightly concave in order to best direct the flame. The dispersion plate 69 is positioned a selected distance from the flame head 65 and arranged to deflect the associated flame 64 radially outward toward the jacket interior surface 51. A pair of centralizer arms (indicated as 71 in FIG. 9) are mounted at a central pivot point. The centralizer arms are spring loaded to expand outwardly to the position shown in FIG. 9, but can also be collapsed inwardly in order to allow the apparatus to be introduced into the mouth opening of the jacket. Longitudinal movement of the ignited device along the length of the plastic jacket 13 provides an even scoring of the interior surface 51.

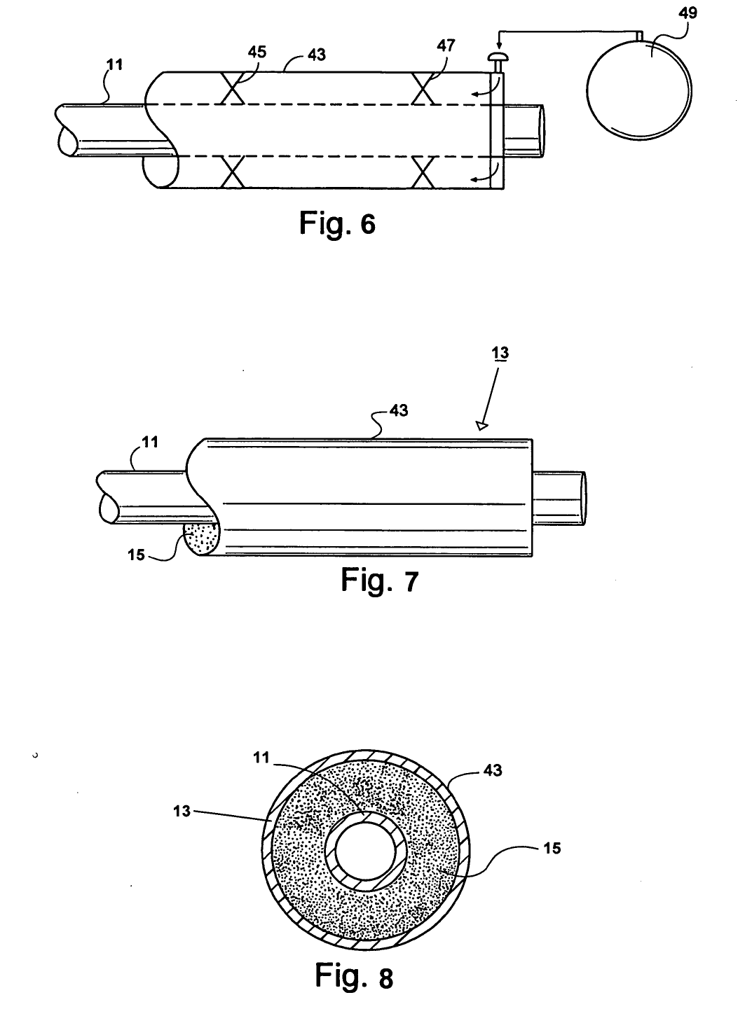

Once the outer protective jacket 13 has been flame treated with the brush flame apparatus 61, a steel carrier pipe 11 is placed inside the plastic jacket 13, as shown in FIG. 5. The steel carrier pipe 11 has an exterior 81 and interior surface 83, and has an open interior. The steel carrier pipe is placed within the plastic jacket and centered by means of standoffs 45, 47 as shown in FIG. 6. This positioning of the carrier pipe 11 creates an annular space 91 between the exterior of the steel pipe and the interior surface of the surrounding jacket. A foam insulating material from a suitable supply source 49 is then pumped into the annular space 91 between the exterior of the carrier pipe and the interior of the plastic jacket. The foam is initially in the form of a liquid or semi-liquid and is allowed to set or cure within the annulus between the inner pipe and outer jacket. FIG. 6 is intended to illustrate the foam injection step while FIG. 7 shows the final, cured insulation within the annular space.

The particular type of foam insulation utilized will depend upon the requirements of the particular end use for the piping system. For lower temperature application, a polyurethane foam insulation may be utilized. For higher temperature (steam) systems above about 250° F., the polyisocyanurate family of foams are preferred. Due to the “stickier” surface of the interior of the flame-treated plastic pipe, the insulating foam has been found to form a more uniform bond to the interior jacket surface. FIG. 8 is an end view of a section of the completed pre-insulated piping of the present invention.

An invention has been provided with several advantages. The method of the present invention improves the adhesion qualities of the interior of the outer protective jacket in order to ensure a uniform bonding of the insulating foam to the interior surface of the plastic jacket. The brush flame apparatus is constructed in such a way as to provide an even oxidation along the length of the jacket interior surface, while avoiding any damage to the surface being treated or reducing the functionality of the plastic jacket as a whole. The present system provides a more integrally sealed environment for the inner carrier pipe which resists the intrusion of water or other contaminants which could cause rust or corrosion. The flame brush apparatus which is utilized in the practice of the invention is simple in design and economical to manufacture and use. The method of the invention is therefore more economical to implement than more exotic treatments, such as corona treatment processes, and the like.

While the invention has been shown in one of its forms, it is not thus limited but is susceptible to various changes and modifications without departing from the spirit thereof.

What is claimed is:

1. A method of manufacturing a length of pre-insulated piping of the type having an inner steel carrier pipe surrounded by an outer layer of insulating foam and, in turn, an outer waterproof plastic jacket, in order to ensure a more uniform bond between the layer of foam insulation and the outer waterproof plastic jacket, the method comprising the steps of:
providing a generally cylindrical length of plastic jacket having an exterior surface and an interior surface;
flame treating the interior surface of the plastic jacket in order to improve the adhesion qualities thereof;
providing an inner steel carrier pipe having an exterior and an initially open interior;
placing the inner steel carrier pipe inside the plastic jacket to thereby create an annular space between the steel carrier pipe and the interior surface of the jacket;
injecting an uncured insulating foam within the annular space between the exterior of the steel carrier pipe and the interior surface of the plastic jacket;
allowing the uncured foam to cure, thereby creating a bond between the cured foam, the exterior of the steel pipe and the interior surface of the plastic jacket.

2. The method of claim 1, wherein the plastic jacket is a polyolefin.

3. The method of claim 2, wherein the plastic jacket is polyethylene.

4. The method of claim 1, wherein the insulating foam is a polyurethane foam.

5. The method of claim 1, wherein the insulating foam is a polyisocyanurate foam.

6. The method of claim 1, wherein the flame treatment is performed with a brush burner.

7. A method of manufacturing a length of pre-insulated piping of the type having an inner steel carrier pipe surrounded by an outer layer of insulating foam and, in turn, an outer waterproof plastic jacket, in order to ensure a more uniform bond between the outer foam insulation and the outer waterproof plastic jacket, the method comprising the steps of:
providing a generally cylindrical length of plastic jacket having an exterior surface and an interior surface and an interior length;
positioning a brush flame apparatus within the interior of the plastic jacket, the apparatus being movable longitudinally along the interior length of the jacket;
igniting the brush flame apparatus and moving the apparatus along the interior length of the jacket to thereby flame treat the interior surface of the plastic jacket in order to oxidize the surface thereof and thereby provide a surface with improved adhesion properties;
providing an inner steel carrier pipe having an exterior and an initially open interior and placing the steel carrier pipe within the jacket interior, thereby creating an annular space between the steel carrier pipe and the jacket interior surface;
injecting an uncured insulating foam within the annular space between the exterior of the steel carrier pipe and the interior surface of the plastic jacket;
allowing the uncured foam to cure, thereby creating a bond between the cured foam, the exterior of the steel pipe and the interior surface of the plastic jacket.

8. The method of claim 7, wherein the brush flame apparatus has a handle and wherein the apparatus is moved within the jacket interior in a back and forth path of travel by hand.

9. The method of claim 8, wherein the brush flame apparatus includes a flame head, the head having a plurality of flame openings, and wherein a dispersion plate is mounted in front of the flame openings in order to direct the flames radially outward toward the interior surface of the jacket.

10. The method of claim 9, wherein the brush flame apparatus is provided with a centralizer mechanism for centering the apparatus within the interior of the plastic jacket.
